(19) United States
(12) Patent Application Publication
(10) Pub. No.: US 2017/0014742 A1
(43) Pub. Date: Jan. 19, 2017

(54) BOP WATER FILTER CARTRIDGE

(71) Applicant: Imerys Filtration Minerals, Inc., San Jose, CA (US)

(72) Inventors: David GITTINS, Truro, Cornwall (GB); Kyle FLOTLIN, Sunnyvale, CA (US)

(73) Assignee: Imerys Filtration Minerals, Inc., San Jose, CA (US)

(21) Appl. No.: 15/302,429

(22) PCT Filed: Apr. 6, 2015
(86) PCT No.: PCT/US2015/024542

§ 371 Date: Oct. 6, 2016

Related U.S. Application Data
(60) Provisional application No. 61/976,156, filed on Apr. 7, 2014.

(51) Int. Cl. B01D 39/20; C02F 1/28; C02F 1/32; A01N 59/16; C02F 1/50; C02F 1/76; C04B 35/14; C04B 38/00; C02F 1/00; C02F 1/44

(52) U.S. Cl. CPC B01D 39/2068; C02F 1/001; C02F 1/283; C02F 1/32; C02F 1/44; C02F 1/505; C02F 1/76; C04B 35/14; C04B 38/0054; A01N 59/16; C02F 2303/04; B01D 2239/1216; B01D 2239/0407; B01D 2239/0442; C04B 2235/3418; C04B 2235/349

(57) ABSTRACT

A water filter may include a diatomite-based ceramic filter having a median pore size greater than about 5 microns, and at least one of a halogen source, a UV source, an active carbon source, or a filtration membrane. A method of filtering water includes passing water from a source chamber through a diatomite-based ceramic filter having a median pore size greater than about 5 microns, and passing the water through at least one of a halogen source, an active carbon source, a UV source, or a filtration membrane to a collection chamber. The diatomite-based ceramic filter may further include bentonite. The water filter may include a biocide. The water filter may have a flow rate greater than about 5 L/hr when normalized to a surface area of 0.015 m². The water filter may reduce bacteria by greater than about 6-log. The halogen source may include a halogen elution system or a surface modification of the diatomite-based ceramic filter.

### CLAIM FOR PRIORITY

This PCT international Application claims the benefit of priority of U.S. Provisional Patent Application No. 61/976,156, filed Apr. 7, 2014, the subject matter of which is incorporated herein by reference in its entirety.

### DESCRIPTION OF THE DISCLOSURE

Field of the Disclosure

The present disclosure relates to a diatomite-based ceramic filter for filtering water. This disclosure also relates to a method for filtering water.

Background

Water filters are used to remove bacteria and other contaminants from water, thereby rendering the water safe for human use or consumption.

When used for filtration, water is introduced on one side of the ceramic filter and passes through the filter, which removes contaminants. Filtration through ceramic filters is generally accomplished by the pore size of the ceramic through physical exclusion of bacteria and microbes, which are too large to pass through the pores. Accordingly, ceramic filters typically have very small pore sizes, on the order or 0.1 microns to about 2 microns, which are too small for bacteria, protozoa, and other microbes to penetrate. The bacteria and microbes are blocked by the small pore size, filtering them from the water.

This small pore size may be disadvantageous in that it decreases the efficiency of filtration. Small pore sizes are restrictive, and the water flows slowly through the filter. Accordingly, it may require an undesirably long period of time to filter a desired volume of water when using ceramic filters. Filtration rate can be increased by increasing the pore size of the ceramic, but an increase in pore size also results in decreased filtration of bacteria and microbes. As a result, high-flow ceramic filters may not achieve sufficient filtration to render the filtered water suitable for human use.

Ceramic filters alone may be also unsuitable for removing chemical contaminants, such as organic or metallic contaminants, which may pass through even small pores. Granulated active carbon (GAC) may be added to the filter to remove these chemical contaminants. However, the effective life of the GAC may expire before the effective life of the ceramic filter. This may require the filter to be changed more often than would otherwise be necessary. However, without the GAC component, ceramic filters alone are typically insufficient for use on their own.

It may be desirable to produce ceramic filters having a higher flow rate, while still retaining sufficient antimicrobial and antiviral properties. A higher flow rate may be achieved by increasing the pore size of the filter. It may be further desirable to produce effective high-flow ceramic filters at low cost. It may also be desirable to produce a ceramic filter that does not include a carbon core.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

According to one aspect of this disclosure, a water filter may include a diatomite-based ceramic filter having a median pore size greater than about 5 microns, and at least one of a halogen source, a UV source, an active carbon source, or a filtration membrane.

According to another aspect, the median pore size of the diatomite-based ceramic filter may be greater than about 6 microns. For example, the median pore size of the diatomite-based ceramic filter may be greater than about 7 microns, greater than about 8 microns, or greater than about 9 microns.

According to a further aspect, the diatomite-based ceramic filter may be disc-shaped. According to another aspect, the diatomite-based ceramic filter may be candle-shaped.

According to still a further aspect, the diatomite-based ceramic filter may further include bentonite.

According to yet another aspect, the water filter may include a biocide. Exemplary classes of biocides may include, but are not limited to, germicides, bactericides, fungicides, algaeicides, and drinking water disinfectants. Exemplary biocides may include halogen biocides, metallic biocides, organosulfur biocides, nitrogen biocides, or phenolic biocides. Exemplary metallic biocides may include, but are not limited to, silver acetate, silver carbonate, silver chloride, silver copper zeolite, silver fluoride, silver iodide, silver nitrate, silver orthophosphate (Ag₃PO₄), silver oxide (Ag₄O₄), silver salt of partially polymerized mannuronic acid, silver sodium hydrogen zirconium phosphate (Ag_{0.18}Na_{0.57}H_{0.25}Zr₂(PO₄)₃), silver thiocyanate, silver thiuronium acrylate copolymer, silver zeolite, silver zinc zeolite, silver, silver borosilicate, silver magnesium aluminum phosphate, zinc 8-quinolinolate, zinc bacitracin, zinc chloride, zinc dehydroabietylammonium 2-ethylhexanoate, zinc dodecyl benzene sulphonate, zinc silicate, zinc sulfate heptahydrate, zinc sulfate, zinc nitrate, anhydrous zinc trichlorophenate ziram, copper sulfate, copper nitrate, copper thiocyanate, elemental copper, elemental silver, elemental zinc, copper ions, silver ions, and zinc ions. According to yet another aspect, the biocide may include an antimicrobial-metal compound, such as, for example, a copper compound, a silver compound, or a zinc compound.

According to a further aspect, the flow rate of the water filter may be greater than about 4 L/hr when normalized to a surface area of 0.015 m² and about six inches of head pressure. For example, the flow rate of the water filter, when normalized to a surface area of 0.015 m² and about six inches of head pressure, may be greater than about 5 L/hr, greater than about 6 L/hr, greater than about 7 L/hr, greater than about 8 L/hr, greater than about 9 L/hr, or greater than about 10 L/hr.

According to still another aspect, the diatomite-based ceramic filter may reduce bacteria by greater than about 3-log (i.e., 99.9%), but less than about 5-log (i.e., 99.999%). According to a further aspect, the water filter may reduce bacteria by greater than about 5-log (i.e., 99.999%). For example, the water filter may reduce bacteria by greater than about 6-log (i.e., 99.9999%), by greater than about 7-log (i.e., 99.99999%), or greater than about 8-log (i.e., 99.999999%).

According to yet another aspect, the water filter may not include active carbon or granulated active carbon (GAC).

According to another aspect, the water filter may include a halogen source, and the halogen source may include at least one of bromine, chlorine, or iodine. The halogen source may include a halogen elution system in series with the diatomite-based ceramic filter. The halogen source may also be incorporated into one or more cavities of the diatomite-based ceramic filter. According to still a further aspect, the halogen source may include a surface modification of the diatomite-based ceramic filter.

According to another aspect, the membrane may include a reverse-osmosis membrane, a microfiltration membrane, an ultrafiltration membrane, or a nanofiltration membrane.

According to yet another aspect, a method of filtering water may include passing water from a source chamber through a diatomite-based ceramic filter having a median pore size greater than about 5 microns, and passing the water through at least one of a halogen source, a UV source, an active carbon source, or a filtration membrane to a collection chamber.

According to another aspect, the median pore size of the diatomite-based ceramic filter may be greater than about 6 microns. For example, the median pore size of the diatomite-based ceramic filter may be greater than about 7 microns, greater than about 8 microns, or greater than about 9 microns.

According to a further aspect, the diatomite-based ceramic filter may be disc-shaped. According to another aspect the diatomite-based ceramic filter may be candle-shaped.

According to still another aspect, the diatomite-based ceramic filter may further include bentonite.

According to yet a further aspect, the diatomite-based ceramic filter may include a biocide. Exemplary classes of biocides may include halogen biocides, metallic biocides, organosulfur biocides, nitrogen biocides, or phenolic biocides. Exemplary metallic biocides may include, but are not limited to, germicides, bactericides, fungicides, algaeicides, and drinking water disinfectants. Exemplary biocides may include, but are not limited to, silver acetate, silver carbonate, silver chloride, silver copper zeolite, silver fluoride, silver iodide, silver nitrate, silver orthophosphate (Ag₃PO₄), silver oxide (Ag₄O₄), silver salt of partially polymerized mannuronic acid, silver sodium hydrogen zirconium phosphate (Ag_{0.18}Na_{0.57}H_{0.25}Zr₂(PO₄)₃), silver thiocyanate, silver thiuronium acrylate copolymer, silver zeolite, silver zinc zeolite, silver, silver borosilicate, silver magnesium aluminum phosphate, zinc 8-quinolinolate, zinc bacitracin, zinc chloride, zinc dehydroabietylammonium 2-ethylhexanoate, zinc dodecyl benzene sulphonate, zinc silicate, zinc sulfate heptahydrate, zinc sulfate, zinc nitrate, anhydrous zinc trichlorophenate ziram, copper sulfate, copper nitrate, copper thiocyanate, elemental copper, elemental silver, elemental zinc, copper ions, silver ions, and zinc ions. According to yet another aspect, the biocide may include an antimicrobial-metal compound, such as, for example, a copper compound, a silver compound, or a zinc compound.

According to yet another aspect, the flow rate from the source chamber to the collection chamber may be greater than about 4 L/hr when normalized to a surface area of 0.015 m² of the diatomite-based ceramic filter and about six inches of head pressure. For example, the flow rate from the source chamber to the collection chamber may be greater than about 5 L/hr when normalized to a surface area of 0.015 m² of the diatomite-based ceramic filter and about six inches of head pressure, greater than about 6 L/hr when normalized to a surface area of 0.015 m² of the diatomite-based ceramic filter, greater than about 7 L/hr when normalized to a surface area of 0.015 m² of the diatomite-based ceramic filter and about six inches of head pressure, greater than about 8 L/hr when normalized to a surface area of 0.015 m² of the diatomite-based ceramic filter and about six inches of head pressure, greater than about 9 L/hr when normalized to a surface area of 0.015 m² of the diatomite-based ceramic filter and about six inches of head pressure, or greater than about 10 L/hr when normalized to a surface area of 0.015 m² of the diatomite-based ceramic filter and about six inches of head pressure.

According to still another aspect, the reduction in bacteria in the water after passing from the source chamber through the diatomite-based ceramic filter may be greater than about 3-log, but less than about 5-log.

According to still a further aspect, the reduction in bacteria of the water in the collection chamber when compared to the source chamber may be greater than about 5-log. For example, the reduction in bacteria in the collection chamber when compared to the source chamber is greater than about 6-log, greater than about 7-log, or greater than about 8-log.

According to still another aspect, the method does not include filtering the water through active carbon between the source chamber and the collection chamber.

According to another aspect, the method may include passing the water through a halogen source, and the halogen source may include at least one of bromine, chlorine, or iodine. The halogen source may include a halogen elution system in series with the diatomite-based ceramic filter. The halogen source may also be incorporated into one or more cavities of the diatomite-based ceramic filter. According to still a further aspect, the halogen source may include a surface modification of the diatomite-based ceramic filter.

According to another aspect, the membrane may include a reverse-osmosis membrane, a microfiltration membrane, an ultrafiltration membrane, or a nanofiltration membrane.

Exemplary objects and advantages will be set forth in part in the description which follows, or may be learned by practice of the exemplary embodiments.

It is to be understood that both the foregoing general description and the following detailed description are exemplary and explanatory only and are not restrictive of the invention, as claimed.

### BRIEF DESCRIPTION OF THE DRAWINGS

FIG. 1 shows the pore-size distribution for some exemplary embodiments of a diatomite-based ceramic filter.

FIG. 2 shows the log reduction in bacteria for an exemplary diatomite-based ceramic filter in combination with a halogen source and GAC.

FIG. 3 shows exemplary flow rates of exemplary diatomite-based ceramic filters.

### DESCRIPTION OF EXEMPLARY EMBODIMENTS

According to some exemplary embodiments, a water filter may include a diatomite-based ceramic filter having a median pore size greater than about 5 microns, and at least one of a halogen source, a UV source, an active carbon source, or a filtration membrane.

Diatomite (also called “diatomaceous earth” or “DE”) is generally known as a sediment-enriched in biogenic silica (i.e., silica produced or brought about by living organisms) in the form of siliceous skeletons (frustules) of diatoms. Diatoms are a diverse array of microscopic, single-celled, golden-brown algae generally of the class Bacillariophyceae that possess an ornate siliceous skeleton of varied and intricate structures including two valves that, in the living diatom, fit together much like a pill box.

Diatomite may form from the remains of water-borne diatoms and, therefore, diatomaceous earth deposits may be found close to either current or former bodies of water. Those deposits are generally divided into two categories based on source: freshwater and saltwater. Freshwater diatomaceous earth is generally mined from dry lakebeds and may be characterized as having a low crystalline silica content and a high iron content. In contrast, saltwater diatomaceous earth is generally extracted from oceanic areas and may be characterized as having a high crystalline silica content and a low iron content.

Diatomote-based ceramic filters may be formed by mixing diatomite with a binder, such as, for example, bentonite and/or methylcellulose, to form a green body. The green body may then be extruded or pressed into a desired filter shape and fired to form the diatomite-based ceramic filter.

According to some embodiments, the median pore size of the diatomite-based ceramic filter may be greater than about 6 microns. For example, the median pore size of the diatomite-based ceramic filter may be greater than about 7 microns, greater than about 8 microns, or greater than about 9 microns.

As used herein, “median pore size” means the average pore size of the diatomite-based ceramic filter, which may be determined by mercury intrusion porosimetry using a Micromeritics AutoPore porosimeter and following the methodology set forth in the instrument instruction manual.

According some embodiments, the diatomite-based ceramic filter may be disc-shaped or may be candle-shaped. A disc-shaped ceramic filter may be generally cylindrical and includes a diameter that is greater than the height of the filter. A candle-shaped ceramic filter may be a generally cylindrical tube with one or more hollow cavities within the tube. A candle-shaped ceramic filter may also include an end cap for sealing one end of the tube. The end cap may be any shape and may be composed of a diatomite-based ceramic filter material or may be a plug of any material that blocks entry of the water into the candle without passing through the diatomite-based material.

The shape of the diatomite-based ceramic filter is not limited to cylindrical shapes, such as candles and discs. For example, the diatomite-based ceramic filter may be any shape sufficient for filtering water, including, but not limited to, square plates, rectangular prisms, triangular plates or prisms, tubes having rectangular or square cross sections, or hemispherical.

According to some embodiments, the diatomite-based ceramic filter may include one or more cavities. The cavity may contain a further filtration aid, such as, for example, the halogen source, GAC, or a combination thereof.

According some embodiments, the water filter may include bentonite. Bentonite is an aluminum phyllosilicate clay material. Bentonite may be added to the diatomite as a binder and/or plasticizer. The bentonite may enhance the green strength of the diatomite-based ceramic filter body in green form prior to firing. The bentonite may also improve the strength of the fired diatomite-based ceramic filter. According to some embodiments, the ratio of bentonite to diatomite in green form may be 1:5 by weight (bentonite:diatomite), 1:10 by weight, 1:15 by weight, or 1:20 by weight.

According to some embodiments, extrusion aids may also be used when forming the ceramic filter. For example, methylcellulose may be added to a diatomite or diatomite-bentonite mixture to enhance the plasticity of the pre-fired filter materials. The enhanced plasticity may improve the extrusion properties of the green bodies, facilitating formation of filter bodies. According to some embodiments, an extrusion aid, such as methylcellulose, may burn off during the firing process. Extrusion aids other than methylcellulose are also contemplated.

According some embodiments, the water filter may include a biocide. The biocide may improve the bacteria- or microorganism-killing efficiency of the water filter. The biocide may also prohibit growth of bacteria, mold, algae, and other organisms on the filter itself. When the biocide contains an antimicrobial metal compound, the compound may be converted to an antimicrobial metal, such as, for example, silver, copper, or zinc, during formation of the diatomite-based ceramic filter, such as during a firing of the ceramic.

Exemplary classes of biocides may include, but are not limited to, germicides, antibiotics, antibacterials, antivirals, antifungals, antiprotozoals, and antiparasitics, algaecides, and drinking water disinfectants. Exemplary biocides may include, but are not limited to, silver acetate, silver carbonate, silver chloride, silver copper zeolite, silver fluoride, silver iodide, silver nitrate, silver orthophosphate (Ag₃PO₄), silver oxide (Ag₄O₄), silver salt of partially polymerized mannuronic acid, silver sodium hydrogen zirconium phosphate (Ag_{0.18}Na_{0.57}H_{0.25}Zr₂(PO₄)₃), silver thiocyanate, silver thiuronium acrylate copolymer, silver zeolite, silver zinc zeolite, silver, silver borosilicate, silver magnesium aluminum phosphate, zinc 8-quinolinolate, zinc bacitracin, zinc chloride, zinc dehydroabietylammonium 2-ethylhexanoate, zinc dodecyl benzene sulphonate, zinc silicate, zinc sulfate heptahydrate, zinc sulfate, zinc nitrate, anhydrous zinc trichlorophenate ziram, copper sulfate, copper nitrate, copper thiocyanate, elemental copper, elemental silver, elemental zinc, copper ions, silver ions, and zinc ions. According to yet another aspect, the biocide may include an antimicrobial-metal compound, such as, for example, a copper compound, a silver compound, or a zinc compound.

According some embodiments, the flow rate of the water filter may be greater than about 4 liters per hour (L/hr) when normalized to a surface area of 0.015 m² of the diatomite-based ceramic filter. For example, the flow rate of the water filter, when normalized to a surface area of 0.015 m² of the diatomite-based ceramic filter and about six inches of head pressure, may be greater than about 5 L/hr, greater than about 6 L/hr, greater than about 7 L/hr, greater than about 8 L/hr, greater than about 9 L/hr, or greater than about 10 L/hr when normalized to a surface area of 0.015 m² of the diatomite-based ceramic filter and about six inches of head pressure.

The volumetric flow rate of the a filter may generally be determined by the equation

Q=A*K*(ΔhlI)

where Q is the volumetric flow rate, A is the flow area perpendicular to the flow path length l, K is the hydraulic conductivity, and Δh is the change in the hydraulic head h over the path I. When comparing filters of different shapes, it may be desirable to normalize the measured flow rates to a common surface area to account for differences in flow resulting from larger or smaller filters. In the examples of this disclosure, the flow rate was normalized to about six inches of head pressure. For each sample tested the head pressure was normalized to the head pressure generated using about six inches of water above the top of the ceramic filter in a water source. Normalization of both the pressure and the surface area may allow for a comparison of different form factors of the diatomite-based ceramic filter (e.g., disc-shaped as compared with candle-shaped).

As used herein, a “log reduction” refers to the number of factors of 10 by which microorganisms, such as bacteria, are removed or inactivated by a filter, based on a logarithmic base of 10. For example, a 2-log reduction would equate to 99% removal or inactivation of microorganisms (i.e., 1% remaining or active), a 3-log reduction would equate to a 99.9% removal of microorganisms (i.e., 0.1% remaining or active).

According to some embodiments, the diatomite-based ceramic filter may reduce bacteria by greater than about 3-log. For example, the diatomite-based ceramic filter may reduce bacteria by greater than about 3-log, but less than about 5-log.

According to some embodiments, the water filter may reduce bacteria by greater than about 5-log. For example, the water filter may reduce bacteria by greater than about 6-log, by greater than about 7-log, or greater than about 8-log.

According some embodiments, the water filter may include active carbon or granulated active carbon (GAC). Active carbon or GAC may include carbon that contains a high surface area. The high surface area may be created by introducing many small, low-volume pores into the carbon material, which may enhance the chemical absorption of the carbon. According to some embodiments, the active carbon or GAC may be derived from carbonaceous source materials, such as, for example, charcoal, biochar, coal, wood, nut shells, or peat. According to some embodiments, the water filter may not include active carbon or GAC.

According to some embodiments, the water filter may include a halogen source, and the halogen source may include at least one of bromine, chlorine, or iodine. According to some embodiments, the halogen source may include a halogen elution system, such as, for example, the HALOPURE® system available from HaloSource. A halogen elution system may include may include a device, such as a filter or membrane, containing the halogen, such as, for example, halogen atoms that form halogen-based ions, a halamine, N-halamine, or quaternary ammonium compound, including but not limited to, n-alkyl dimethylbenzylammonium chlorides and n-alkyl dimethyl ethylbenzylammonium chlorides. The passage water over the halogen source may cause the halogen to elute into the water, and may cause the formation of halogen-based ions. According to some embodiments, the halogen elution system may release halogen from a surface over a period of time. The presence of the halogen may further kill or inactivate bacteria, protozoa, or or microorganisms. The halogen may also kill viruses that pass through the diatomite-based ceramic filter. The halogen elution system may be used in series with the diatomite-based ceramic filter, such that the water first passes through the diatomite-based ceramic filter then through the halogen elution system.

Without wishing to be bound by a particular theory, it is believed that the series configuration may enhance the efficiency of the water filter. A halogen-based filtration system may generally be inefficient by itself because protozoa are often resistant to the halogen, and the presence of bacteria and sediment further attenuates the halogen's performance against bacteria and viruses. By placing a diatomite-based ceramic filter before the halogen elution system in the water filter, the ceramic filter removes sediment, bacteria, and protozoa that might otherwise attenuate or inhibit the efficiency of the halogen elution system. The halogen elution system may then be more effective at killing viruses and bacteria because it is not inhibited by the sediment and other materials removed by the ceramic filter.

According to some embodiments, the halogen source may also be incorporated into one or more cavities of the diatomite-based ceramic filter. A ceramic filter, such as a candle-shaped filter or tube-shaped filter, may include a cavity or other chamber where the halogen source may be incorporated. For example, a candle-shaped filter may be shaped like a hollow cylinder. The unfiltered water outside of the cylinder in a source chamber passed through the ceramic filter into the hollow cavity. The cavity may contain an insert including the halogen source, such as, a halogen elution system. The cavity generally contains water filtered by the ceramic filter, which then passes through an opening to a collection chamber or receptacle for its intended use (e.g., for drinking or cooking).

According to some embodiments, the halogen source may include a replaceable device that may be inserted into the cavity of the diatomite-based ceramic filter. For example, the halogen source may be a cylindrical cartridge having a cross section that is the same size and shape as the filter's cavity. When the usable life of the halogen source has expired, the halogen source cartridge may be replaced with a new cartridge, thereby extending the usable life of the ceramic filter.

According some embodiments, the diatomite-based ceramic may include a surface modification, such as, for example, a halogen source; an oxide, such as goethite; metal oxyhydroxides, such as iron, aluminum, zirconium, magnesium, or yttrium oxyhydroxides; or a quaternary ammonium compound, such as n-alkyl dimethylbenzylammonium chlorides or n-alkyl dimethyl ethylbenzylammonium chlorides. The surface modification of the filter or of a material incorporated into a cavity of the diatomite-based ceramic filter. For example, the halogen atoms, ions, or compounds may be diffused into the diatomite. According to some embodiments, diffusion of the halogen into the diatomite may be achieved through, for example, gas ion exchange. The ion exchange may be performed on the source diatomite prior to forming the diatomite-based ceramic filter, or may be performed on the diatomite-based ceramic filter itself. When the filter includes a cavity, the surface modification may take place within the cavity to enhance the antimicrobial and antiviral properties of the halogen source.

According to some embodiments, the surface modification may include electrochemically modifying the surface of the diatomite or diatomite-based ceramic filter. According to some embodiments, the halogen source may release halogen atoms or halogen ions into the water, improving the efficiency of the halogen source.

According to some embodiments, the water filter may include an ultraviolet light (UV) source. UV light, a form of electromagnetic energy with a wavelength between x-rays and visible light, can be emitted from special lamps or bulbs. Without wishing to be bound by a particular theory, it is believed that UV light may kill or inactivate microorganisms at a genetic level that prohibits the microorganism's ability to replicate. UV light may also be beneficial in that it does not add chemicals to the water. UV light is effective at killing or inactivating microorganisms without affecting the taste or odor of water. Without wishing to be bound by a particular theory, it is believed that the effectiveness of UV light may be enhanced by the diatomite-based ceramic filter, which may filter sediment and significant portions of bacteria prior to UV light exposure.

According to some embodiments, the water filter may include a membrane, a filter cloth, or a filter pad. The membrane may include a reverse-osmosis membrane, a microfiltration membrane, ultrafiltration membrane or a nanofiltration membrane. Membrane filtration may be accomplished based on pore sizes in the membrane. In general, the larger the pore size, the more contaminants will pass through the membrane. For example, a microfiltration membrane may block bacteria and sediment from passing through the membrane, but may not block viruses or chemical ions. Ultrafiltration membranes may further block viruses, and nanofiltration membranes may further block some ions, such as multivalent ions, but not monovalent ions. Reverse osmosis may not be strictly a pore-size filtration technique. Rather it may use applied pressure to pass water through a semipermeable membrane, driven by a chemical potential across the membrane. It is believed that reverse osmosis membranes effectively block all contaminants, leaving only water molecules.

### Example 1

Disc-shaped diatomite-based ceramic filters were prepared according to the following process. 300 grams of diatomite having a median particle size (d₅₀) of 29 microns was mixed with 30 grams of bentonite. The mixture was blended at low speed for 10 minutes to ensure homogeneity. About 255 grams of water were added slowly during mixing to hydrate the powders. The hydrated powder was then mixed for 30 minutes, stopping occasionally to redistribute powder that had clung to the sides of the blender.

The mixed powder was then formed into 9.6 cm diameter disks with a thickness of 0.6-0.9 cm. The discs were prepared using a custom steel puck press and a Carver pneumatic press. Approximately one-fifth of the mixed powder was added to the chamber of the steel puck press and distributed evenly. The puck press was then loaded into the Carver press and subjected to 1000 psi (69 bar) for one minute. Once the pressure was removed, the press was opened and the disk set aside. This process was repeated until the mixture material was exhausted. The pressed disks were dried in an oven overnight at 80° C. The dried disks were then fired at 1000° C. for two hours. The firing included a two-and-a-half hour ramp-up period from room temperature. The fired discs were then cooled to ambient temperature in the oven for 12 to 20 hours.

### Example 2

A second set of disc-shaped diatomite-based ceramic filters were prepared according to Example 1, except that 0.2 grams of silver nitrate were dissolved in the water prior to adding the water during mixing.

### Example 3

Candle-shaped diatomite-based ceramic filters were prepared according to the following process. 500 grams of diatomite having a 29-micron particle size were mixed with 50 grams of bentonite and 25 grams of methylcellulose. About 615 grams of water were added slowly during mixing to hydrate the powders. The hydrated powder was then mixed until a dense, plastic consistency was obtained.

The mixed material was then formed into hollow tube having a 2-inch outer diameter and a 1.5-inch inner diameter using a hand-powered clay extrusion press. Prior to pressing, air bubbles in the material were removed by loading it into the press with the cap attached and then applying pressure to compress the material into the press. The cap was then switched for the proper extrusion cap, and the green-body material was extruded in 6-inch lengths around a 1.5-inch diameter PVC pipe to preserve the structure of the tubes during drying. This process was repeated until all of the material was used.

The samples were then air-dried at ambient temperatures overnight. After air drying, the PVC pipe was removed and samples were oven-dried at 80° C. overnight. The dried samples were then fired at 1000° C. for two hours, as described in Example 1, including a temperature ramp-up period and cool down period. The fired samples were then cut and sanded to facilitate attachment of end caps for filter testing.

### Example 4

Diatomite-based ceramic filters were prepared according to the process of Example 1, except that the diatomite had a median particle size (d₅₀) of 42 microns.

### Example 5

Diatomite-based ceramic filters were prepared according to the process of Example 2, except that the diatomite had a median particle size (d₅₀) of 42 microns.

### Example 6

Diatomite-based ceramic filters were prepared according to the process of Example 3, except that the diatomite had a median particle size (d₅₀) of 42 microns.

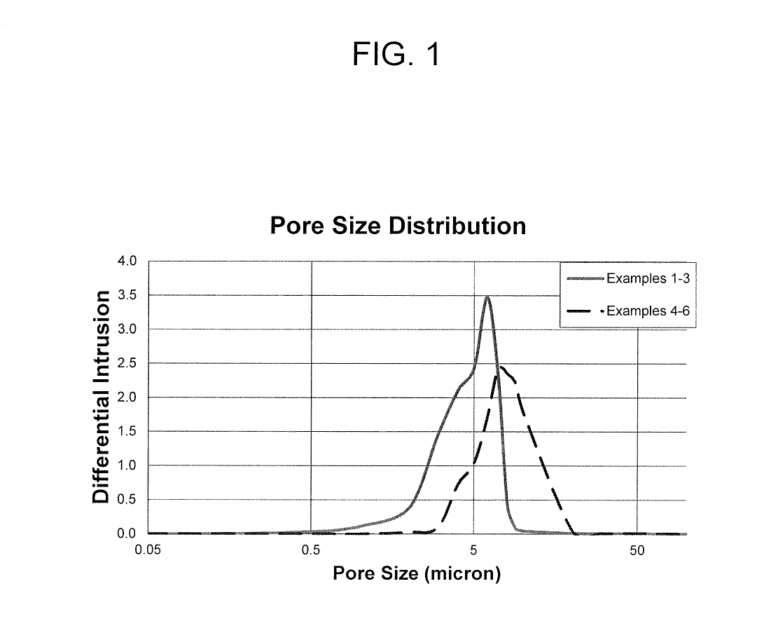

The pore size distribution of the diatomite-based ceramic filters of Examples 1-6 was measured using mercury intrusion porosimetry. The pore-size distributions are shown in FIG. 1.

As shown in FIG. 1, Examples 1-3 have a pore-size distribution ranging from 0.5 microns to about 9 microns, with a median pore size of about 5 microns. Examples 4-6 have a pore-size distribution ranging from about 3 microns to about 20 microns with a median pore-size distribution of about 7.5 microns.

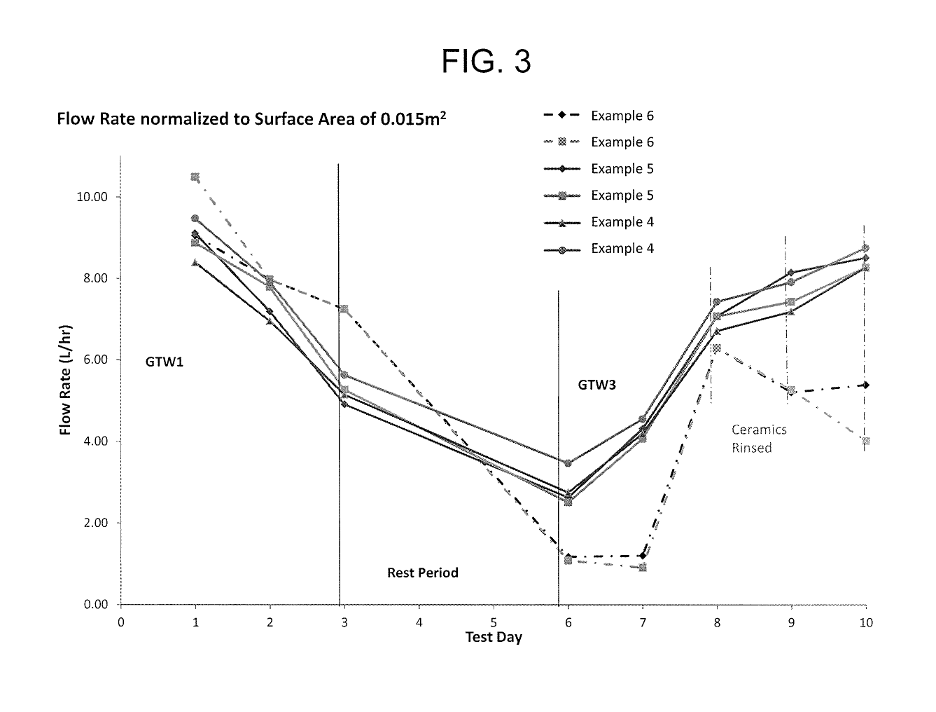

Flow rates were measured using mercury intrusion porosimetry for each of the diatomite-based ceramic filters in Examples 4-6, as shown in FIG. 3. The initial flow rates for all samples were all greater than 8.0 L/hr when normalized to a surface area of 0.015 m² and about six inches of head pressure. More specifically, the flow rates for each filter varied between about 8.5 L/hr and 10.5 L/hr when normalized to a surface area of 0.015 m² and about six inches of head pressure.

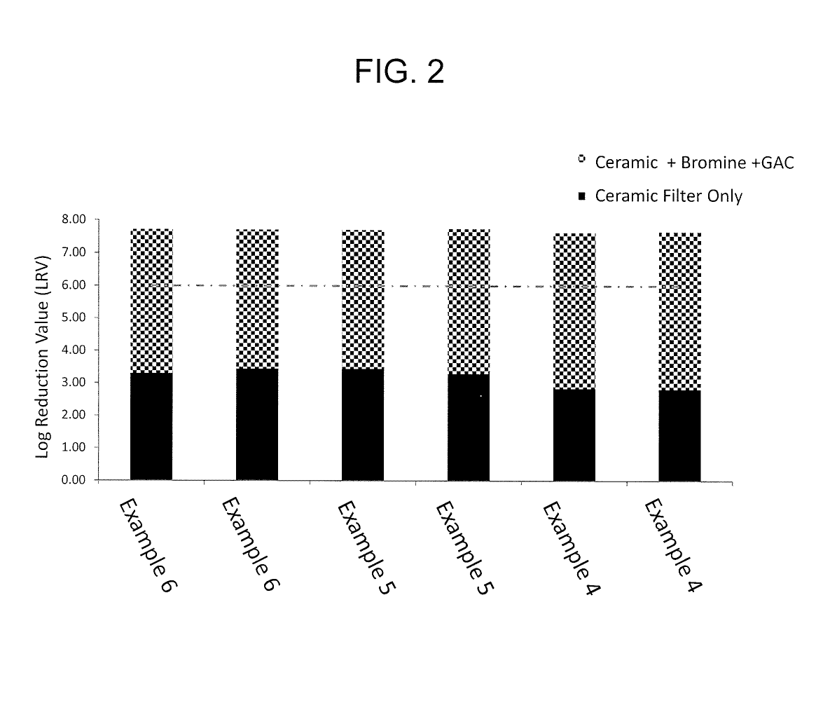

FIG. 2 shows the log reduction of bacteria through the exemplary filters of Examples 4-6 in combination with a halogen source and GAC. For each filter, influent water was filtered from a source chamber through the diatomite-based ceramic filter. The water was then passed through a second filter containing a bromine-elution source positioned in series after the diatomite-based ceramic filter, where it passed to a collection chamber. The bromine-elution source is a slow-release HALOPURE® device in which bromine reacts with water to produce hypobromite ions (OBr⁻) into the water filtered through the diatomite-based ceramic filter.

As shown in FIG. 2, the performance of the diatomite-based filters of Examples 4-6 are similar. For each of the diatomite-based filters in Examples 4-6, the diatomite-based filter alone achieved greater than 3-log reduction in bacteria. Subsequent filtration through the bromine-elution resulted in a further 4-log reduction in bacteria. The total bacteria reduction of the diatomite-based ceramic filter with the bromine-elution source was greater than 7-log reduction in bacteria. GAC removed color- and odor-causing compounds. FIG. 2 demonstrates that relatively large pore-size diatomite-based ceramic filters may be used to achieve relatively high flow rates of filtration while still effectively filtering contaminants, such as sediment, bacteria, protozoa, and viruses, to create potable or drinkable water.

Additional testing also showed that the diatomite-based ceramic filters in combination with the bromine-elution source achieved greater than a 6-log reduction in viruses.

Although the examples above are discussed in terms of a bromine-elution source, it is contemplated that other halogens may be used, such as iodine or chlorine. Similarly, non-elution sources of the halogen may also be used, as described above.

Other embodiments of the invention will be apparent to those skilled in the art from consideration of the specification and practice of the exemplary embodiments disclosed herein. It is intended that the specification and examples be considered as exemplary only, with a true scope and spirit of the invention being indicated by the following claims.

1. A water filter comprising:
a diatomite-based ceramic filter having a median pore size greater than about 5 microns; and
at least one of a halogen source, a UV source, an active carbon source, or a filtration membrane.

2. (canceled)

3. (canceled)

4. The water filter of claim 1, wherein the diatomite-based ceramic filter is disc-shaped.

5. The water filter of claim 1, wherein the diatomite-based ceramic filter is candle-shaped.

6. The water filter of claim 1, wherein the diatimote-based ceramic filter further comprises bentonite,

7. The water filter of claim 1, further comprising a biocide.

8. The water filter of claim 7, wherein the biocide comprises at least one of germicides, bactericides, fungicides, algaeicides, and drinking water disinfectants.

9. The water filter of claim 7, wherein the biocide comprises at least one silver acetate, silver carbonate, silver chloride, silver copper zeolite, silver fluoride, silver iodide, silver nitrate, silver orthophosphate (Ag₃PO₄), silver oxide (Ag₄O₄), silver salt of partially polymerized mannuronic acid, silver sodium hydrogen zirconium phosphate (Ag_{0.18}Na_{0.57}H_{0.25}Zr₂(PO₄)₃), silver thiocyanate, silver thiuronium acrylate copolymer, silver zeolite, silver zinc zeolite, silver, silver borosilicate, silver magnesium aluminum phosphate zinc 8-quinolinolate, zinc bacitracin, zinc chloride, zinc dehydroabietylammonium 2-ethylhexanoate, zinc dodecyl benzene sulphonate, zinc silicate, zinc sulfate heptahydrate, zinc sulfate, zinc nitrate, anhydrous zinc trichlorophenate ziram, elemental copper, elemental silver, elemental zinc, copper ions, silver ions, and zinc ions.

10. The water filter of claim 7, wherein the biocide comprises at least one of a copper compound, a silver compound, or a zinc compound.

11. The water filter of claim 1, wherein the flow rate of the water filter is greater than about 4 L/hr when normalized to a surface area of 0.015 m² of the diatomite-based ceramic filter and about six inches of head pressure.

12. (canceled)

13. The water filter of claim 1, wherein the flow rate of the water filter is greater than about 8 L/hr when normalized to a surface area of 0.015 m² of the diatomite-based ceramic filter and about six inches of head pressure.

14. The water filter of claim 1, wherein the diatomite-based ceramic filter reduces bacteria by greater than about 3-log, but less than about 5-log.

15. (canceled)

16. The water filter of claim 1, wherein the water filter reduces bacteria by greater than about 6-log.

17. The water filter of claim 1, wherein the water filter reduces bacteria by greater than about 7-log.

18. The water filter of claim 1, wherein the water filter reduces bacteria by greater than about 8-log.

19. The water filter of claim 1, wherein the water filter does not include active carbon.

20. The water filter of claim 1, wherein the water filter comprises a halogen source, and the halogen source comprises at least one of bromine, chlorine, or iodine.

21. The water filter of claim 1, wherein the water filter comprises a halogen source, and the halogen source comprises a halogen elution system in series with the diatomite-based ceramic filter.

22. The water filter of claim 1, wherein the water filter comprises a halogen source, and the halogen source is incorporated into one or more cavities of the diatomite-based ceramic filter.

23. The water filter of claim 1, wherein the water filter comprises a halogen source, and the halogen source comprises a surface modification of the diatomite-based ceramic filter.

24. A method of filtering water, the method comprising:
passing water from a source chamber through a diatomite-based ceramic filter having a median pore size greater than about 5 microns; and
passing the water through at least one of a halogen source, a UV source, an active carbon source, or a filtration membrane to a collection chamber.

25-46. (canceled)
